(19) United States
(12) Patent Application Publication
(10) Pub. No.: US 2005/0146162 A1
(43) Pub. Date: Jul. 7, 2005

(54) Stainless frame construction for motor vehicles

(75) Inventors: Arndt Gerick, Ulm (DE); Tilmann Haug, Weissenhorn (DE); Stefan Kienzle, Leinfelden - Echterdingen (DE); Wolfgang Kleinekathoefer, Waldstetten (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 11/013,975

(22) Filed: Dec. 16, 2004

(30) Foreign Application Priority Data
Dec. 19, 2003 (DE) DE103 59 786.7-21

(51) Int. Cl. B62D 29/00

(52) U.S. Cl. 296/203.01; 296/900; 296/901.01; 29/897.2

(57) ABSTRACT

A motor vehicle having a stainless supporting frame structure or a stainless body-in-white, including a supporting frame structure and flat body components mounted thereon, the supporting frame structure being formed of rust-resistant steels as well as light metal alloys and/or plastics and the flat body components being formed of rust-resistant steels, light metal alloys and/or plastics, the surface of the supporting frame structure or the body-in-white being free of anti-corrosion coating or anti-corrosion painting. In addition, a method for manufacturing a motor vehicle having a corrosion-resistant body-in-white includes the steps of: manufacturing a supporting frame structure by joining and/or welding together rust-resistant steels; and mounting flat body components and/or body panels made of light metals, plastics, or rust-resistant steels, thereby forming the body-in-white. A color-providing surface coating of the body-in-white is directly applied to the uncoated surface of the rust-resistant steels, light metals, or plastics.

Priority is claimed to German Patent Application No. DE 103 59 786.7, filed on Dec. 19, 2003, the entire disclosure of which is incorporated by reference herein.

The present invention relates to motor vehicles having a stainless supporting frame structure or a stainless body-in-white, including a supporting frame structure and flat body components mounted thereon. The supporting frame structure is made of rust-resistant steels, as well as light metal alloys and/or plastics, while the body components are completely made of rust-resistant steels, light metal alloys and/or plastics.

Moreover, the present invention relates to a method for manufacturing a motor vehicle having a corrosion-resistant body-in-white, including the steps of manufacturing a supporting frame structure by joining rust-resistant steels and mounting flat body components and/or body panels made of light metals, plastics, or rust-resistant steels.

### BACKGROUND

With regard to body construction methods, current designs in automotive engineering are moving from the steel shell construction toward the steel supporting frame structure (also known as steel space frame construction). The body is formed here in principle from a lattice structure which is made up of profiles, joint elements, and possibly sheet metal components made of steel and body panels made of sheet steel, as well as other materials such as light metals or plastics. This construction method is relevant in particular for lightweight construction. Steels of different grades and different physical properties are customarily used here in order to meet the different design-engineering demands of the body.

The conventional steel shell construction, as well as the more recent steel space frame construction, provides as a general rule a surface-covering anti-corrosion coating. Even if modern rust-resistant steels are used in the supporting frame structure, this use is limited to a few special parts or components for economic reasons, the predominant portion of the supporting frame structure being made of conventional and cost-effective steels. Therefore it is also customary in this case to apply a surface-covering anti-corrosion coating.

The customary anti-corrosion coatings include coatings or paints which are applied to the metallic ground using cathodic dip painting (CDP). The electro dip paints are aqueous suspensions of binding agents and pigments containing only small concentrations of organic solvents (approximately 3%). The binding agents in typical CDP systems contain a larger part of epoxy resin and a smaller part of acrylic resin (for one-layer paint systems). A current is applied for deposition of the dispersed (or also emulsified) paint particles, the current electrophoretically moving the paint particles to the cathode where they are electrically discharged. Through this, a coagulation of the paint particles takes place on the metallic ground. The paint is deposited on the work piece as an irregular, porous layer which only in the subsequent baking process melts to form an even, compact paint film. In particular in the automotive supply industry, this method meets the highest demands on the protection against rust creep.

Phosphate treatment is one of the frequently used methods for corrosion protection. Metal surfaces, primarily of iron, zinc, and aluminum materials, are treated using aqueous, acid phosphatic solutions with the objective of creating a firmly adhering layer of phosphates. The phosphate treatment is divided into iron phosphatization, zinc phosphatization, and manganese phosphatization according to the most important cation in the layer. The iron phosphate treatment methods are also known as alkali phosphate treatment methods, because they contain alkali metal ions as the most important cations in the treatment solution. The phosphate treatment creates a firmly adhering layer of phosphates which is generally used as the lowest layer in multi-layer systems.

The previously also widely used method of metal chromatizing is increasingly becoming less important for ecological reasons.

The known methods for applying anti-corrosion coatings to the steel space frame or the entire body-in-white of motor vehicles are technologically complex and entail substantial costs. Therefore, there is great economical demand to simplify the methods for corrosion protection and to provide cost-effective, stainless body materials.

### SUMMARY OF THE INVENTION

It is an object of the present invention to provide motor vehicles having body designs in which, by coating them, the corrosion protection is substantially simplified or completely omitted, as well as to present methods for constructing corrosion-protected bodies.

The present invention provides a motor vehicle having a stainless supporting frame structure or a stainless body-in-white, including a supporting frame structure and flat body components mounted thereon, wherein the supporting frame structure is formed of rust-resistant steels as well as light metal alloys and/or plastics, and the flat body components are formed of rust-resistant steels, light metal alloys and/or plastics, and the surface of the supporting frame structure or the body-in-white is free of anti-corrosion coating or anti-corrosion painting. In addition, the present invention provides a method for manufacturing a motor vehicle having a corrosion-resistant body-in-white, that includes the steps of: manufacturing a supporting frame structure by joining and/or welding together rust-resistant steels; and mounting flat body components and/or body panels made of light metals, plastics, or rust-resistant steels, thereby forming the body-in-white, wherein the color-providing surface coating of the body-in-white is directly applied to the uncoated surface of the rust-resistant steels, light metals, or plastics.

As used herein, the phrase “formed of rust-resistant steels as well as light metal alloys and/or plastics” shall mean that the component is predominantly formed of rust-resitant steels as well as light metal alloys and/or plastics. Insubstantial portions of the supporting frame structure may be made of another material and still fall within the meaning of the phrase. Similarly, as used herein, a surface being “free of anti-corrosion coating or anti-corrosion painting” shall mean that the predominant is free of anti-corrosion coating or anti-corrosion painting. Again, a vehicle having a supporting frame structure or body-in-white with a surface that includes insubstantial portions include an anti-corrosion coating or painting are intended to be encompassed by the phrase.

Thus according to the present invention, the entire space frame (supporting frame structure) or the entire body-in-white, including the supporting frame structure and flat body components mounted thereon, is formed by using corrosion-resistant materials in the form of stainless steels and light metal alloys, or plastics. This construction according to the present invention allows the application of anti-corrosion paints or coatings to be omitted. According to the present invention, the surface (i.e., the predominant part of the surface) of the supporting frame structure or the body-in-white is free of anti-corrosion coating or anti-corrosion painting. It is important here that the supporting frame structure or the entire body-in-white or also individual flat body components may be based on a hybrid construction method, i.e., a mixture of different metallic and/or polymer materials.

### BRIEF DESCRIPTION OF THE DRAWING

The present invention is described in more detail below. Reference is made to the drawing, in which:

FIG. 1 shows a generic body-in-white of a motor vehicle.

### DETAILED DESCRIPTION

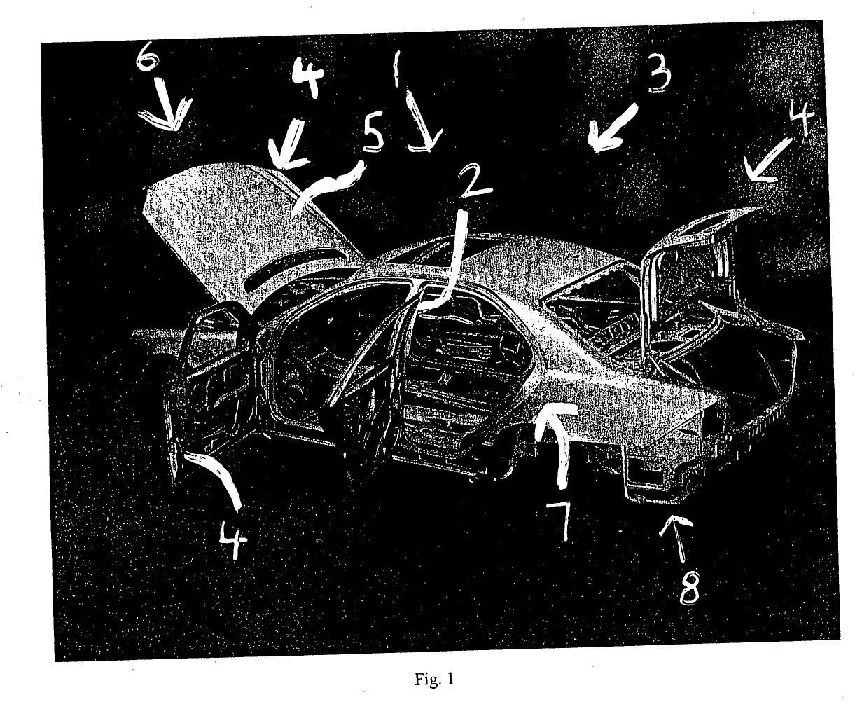

FIG. 1 shows an illustration of a generic body-in-white of a motor vehicle merely to exemplify an object of the present invention and should in no case be construed as being restrictive. The present invention also includes in particular supporting frame structures or bodies-in-white of lower or also higher complexity, such as a smaller or greater number of components.

In FIG. 1, Body-in-white 3 of vehicle 1 includes a stainless supporting frame structure 3 and a plurality of flat body components, such as body panels 4, having a surface 5. The body of vehicle 1 includes a front end section 6, a side section 7 and a rear end section 8.

The supporting frame structure is preferably made of (i.e., a predominant portion of the supporting frame structure is preferably made of) rust-resistant (stainless) steels, and only specific components of the supporting frame structure are manufactured using light metals such as aluminum alloys, or plastics such as fiber reinforced plastics (FRP) or filled polypropylene.

The flat body components may be made of a single material of the listed corrosion-resistant materials, or may also be used in a hybrid construction method. A hybrid construction method is to be understood as using components made of combined materials such as metal/plastic, steel/aluminum, or combined materials such as steel/metal foam, plastic/FRP, or steel/FRP. The flat body components are typically body panels situated in the side section, the rear end section, or the front end section of a vehicle body, thereby forming the hood, the trunk lid, or the doors for example.

In a preferred embodiment of the present invention, at least the flat side components, front end components, and/or rear end components are made of plastic, filled plastic, FRP, or metal/plastic hybrids.

Filled polypropylene, glass fiber reinforced polyester resin, or polyurethane are particularly suited as plastic materials.

Suitable rust-resistant steels must have high corrosion resistance and stability and may not be substantially more expensive than the steels normally used in the automobile body construction. In addition, suitable shaping properties must also be present. Therefore, only specialty steels are essentially suited, such as are presently known from the construction of special machines and miscellaneous applications.

According to the present invention, the following rust-resistant steels are preferred:
low-carbon α steels
Ni-reduced and nitrogenized γ steels
and/or virtually Ni-free α, γ duplex steels having a high Al content

Generic α steels are known, for example, in mechanical engineering for mufflers, catalytic converters, heat exchangers, and pumps where corrosion resistance is required in the high-temperature range. Surprisingly, these steels have high low-temperature corrosion resistance against salt corrosion, as well as adequate stability and malleability for body construction.

With regard to mechanical properties, α steels having the following approximate property profile are preferred:

| | |
|---|---|
| Density | approximately 7.3-7.8 g/ccm |
| Yield strength | approximately 380-530 MPa |
| Tensile strength | approximately 450-720 MPa |
| Breaking elongation | approximately 30%-42% |
| Uniform elongation | approximately 20%-35% |
| Strain-hardening exponent | approximately 0.2 |
| Anisotropy | around 0 |

Preferred α steels have one of the following compositions in weight per cent:
0.03% C; 17.5% to 18.5% Cr; 1% Si; 1% Mn; 0.1% to 0.6% Ti; the rest Fe and usual traces, or
0.03% C; 10.5% to 12.5% Cr; 1% Si; 1% Mn; 0.1% to 0.6% Ti; the rest Fe and usual traces, or
03.025% C; 17% to 20% Cr; 1% Si; 1.8% to 2.5% Mo; 1% Mn;
<0.8% Ti; <0.03% N; the rest Fe and usual traces

Particularly preferred are Al-containing α steels of the following nominal composition in weight per cent:
Al: 5% -9%
Cr: 8% -21%
C: below 0.031%
Fe and usual steel additives: the rest
   Due to their Al content, these steels have a reduced density representing an additional advantage, this density being typically close to or below 7.3 g/ccm. This is particularly important in automotive lightweight construction.

Generic Ni-reduced and nitrogenized γ steels are used, for example, in the areas of chemical apparatus engineering, architecture (facing of buildings), rail vehicles, trucks and buses, as well as kitchen appliances.

With regard to mechanical properties, γ steels having the following approximate property profile are preferred:

| | |
|---|---|
| Density | approximately 7.3-7.8 g/ccm |
| Yield strength | approximately 230-400 MPa |
| Tensile strength | approximately 540-900 MPa |
| Breaking elongation | approximately 40%-65% |
| Uniform elongation | approximately 35%-50% |
| Strain-hardening exponent | approximately 0.4 |
| Anisotropy | around 0 |

Preferred γ steels have one of the following compositions in weight per cent:
0.04% C; 0.05% N; 18% Cr; 8.3% Ni; the rest Fe and usual traces, or
0.02% C; 0.04% N; 17.2% Cr; 10.2% Ni; 2.1% Mo; the rest Fe and usual traces, or
0.1% C; 0.3% N; 17% to 19.5% Cr; 3.5% Ni; 1% Si; 6% to 9% Mn; the rest
Fe and usual traces, or
0.03% C; 0.15% to 0.3% N; 15% to 17% Cr; 1.5% to 3% Ni; 1% Si; 7% to 9% Mn; 1% Cu; the rest Fe and usual traces

γ steels having a further reduced Cr and N content and possibly a slightly increased Ni content are preferably used in particular. In contrast to the above-mentioned preferred γ steels, the following portions of N, Cr, or Ni are preferred: N: 0.1% to 0.2%; Cr: 10% to 15%; Ni: 8% to 15%

This group of steels has good corrosion resistance, in particular in an aqueous medium, as well as improved resistance to crevice corrosion and hole corrosion. Moreover, these steels are comparatively cost-effective due to the reduced Ni content.

Generic α, γ duplex steels are known, for example, in the chemical industry, the petrochemical industry, and off-shore technology.

With regard to mechanical properties, α, γ duplex steels having the following approximate property profile are preferred:

| | |
|---|---|
| Density | approximately 6.7-7.0 g/ccm |
| Yield strength | approximately 300-700 MPa |
| Tensile strength | approximately 650-1200 MPa |
| Breaking elongation | approximately 30%-45% |
| Uniform elongation | approximately 25%-40% |
| Strain-hardening exponent | approximately 0.2-0.3 |
| Anisotropy | around 0 |

Preferred α, γ duplex steels have the following compositions:
0.1% C; 0.3% Si; 6.7% Mn; 18.9% Cr; 0.2% N; 1.5% Ni; the rest Fe and usual traces
0.03% C; 0.22% N; 21.5% Cr; 1.5% Ni; 0.3% Mo; 5% Mn; the rest Fe and usual traces
0.02% C; 5% Mn; 0.4% Si; 20% Cr; 1.6% Ni; 0.3% Cu; 0.13% N; the rest Fe and usual traces

The particularly preferred α, γ duplex steels include grades with high aluminum content having the following approximate composition:
0.3% to 0.8% C; 6% to 18% Al; 15% to 25% Mn; the rest Fe and usual steel additives; Ni only in traces

The preferred phase distribution of the main phases of α, γ duplex steels is at a ferrite content of α=20% to 50% and an austenite content of γ=50% to 80%.

In addition to good corrosion resistance, vis-à-vis chloride-containing media in particular, the α, γ duplex steels feature comparatively high stabilities.

Due to the selection of these rust-resistant steels including low-carbon α steels, Ni-reduced and nitrogenized γ steels, and/or virtually Ni-free α, γ duplex steels with a high Al content, a stainless body-in-white is ensured that also satisfies the demands on the shaping and joining technologies common in automotive engineering.

The preferred shaping techniques, such as deep drawing, compression, molding, collar compression, rolling, or tapering as a rule cause structural changes in the steels which have a substantial effect on the material properties. The desired structure may frequently be restored by re-crystallization processes, via tempering or aging treatments, for example. Therefore, in the selection of the stainless steels according to the present invention, a targeted choice must be made with regard to the suitability for the selected shaping process.

With regard to the manufacturing methods of the stainless steels for the body-in-white according to the present invention, the common manufacturing methods are usable. Multiple components are preferably combined to form entire assembly groups and are manufactured in a single casting process. This concerns also the assembly groups including the flat structures in which the thin-walled cast steel method is used.

Welding in particular should be mentioned with regard to the joining technique used for the individual components or assembly groups. In conventional steels, the weld seams represent as a rule preferred areas of attack for corrosion.

In the construction method according to the present invention, high-grade joints (weld seams) are created during welding of the rust-resistant steels which are able to satisfy even the highest demands on corrosion resistance. In the body-in-white according to the present invention, only stainless/stainless fitting points and joints occur, the joining means being also made of stainless material. Thus, an anti-corrosion coating, such as phosphatizing, chromatizing, or galvanizing, may be dispensed with in areas of the body-in-white which are critical with regard to corrosion resistance. Joints between different steel grades of stainless steels or joints to conventional steels are preferably established using non-welding joining techniques.

When fitting rust-resistant steels with aluminum or plastic parts adhesive technology is preferably used.

It is obvious that a vehicle equipped with the body-in-white according to the present invention, whose body includes individual components made of conventional steels having conventional corrosion protection, is also included in the present invention.

For decorative reasons, the body-in-white according to the present invention has as a rule an exterior colored coating, at least on the visible exterior surfaces of the motor vehicle. This coating may be formed, for example, using paints.

A substantial advantage of the construction method according to the present invention is that comparatively simple paint-layer systems may be used. A multi-layer system, fulfilling anti-corrosion objectives, is generally unnecessary. In particular, it is unnecessary to seal joints, interior spaces, crimps, or lock seams of the rust-resistant steels.

In a further embodiment of the present invention, instead of painting, color films or effect films are used, at least partially.

The predominant part of the flat body components on the exterior surface of the vehicle is preferably covered with a color film or effect film. The inward oriented surfaces of the body-in-white, i.e., the surfaces not visible in the finished motor vehicle, may, in an advantageous manner, remain completely free of additional coatings. Using this construction method, the technically very complex sealing of interior spaces, which are formed by hollow sections or overlapping panel components for example, is omitted.

The predominant part of the visible exterior surface of the vehicle having a body-in-white according to the present invention is preferably covered with a color film or an effect film.

Another aspect of the present invention relates to a method for manufacturing a motor vehicle having a corrosion-resistant body-in-white or assembly groups, including at least the following essential process steps:
a) Manufacturing a supporting frame structure by welding together rust-resistant steels,
b) Mounting flat body components and/or body panels made of light metals, plastics, or rust-resistant resistant steels, thereby forming the body-in white.
c) Applying the color-providing surface coating of the body-in-white directly to the uncoated surface of the rust-resistant steels, light metals, or plastics.

In further process steps, additional structure components made of light metals and/or plastics may be added to the supporting frame structure made of welded rust-resistant steels. In particular, the fiber reinforced plastics are to be understood as being these plastics, such as glass fiber reinforced plastics and carbon fiber reinforced plastics. Adhesive technology in particular is again suitable here as the joining technique, thereby resulting in a body-in-white using a hybrid construction method.

The method according to the present invention also includes the installation of components made of conventional steels having conventional corrosion protection which supplement the supporting frame structure made of welded rust-resistant steels. However, the share of these components is limited to a few exceptions. Preferred components, manufactured using this conventional construction method, are deformation structures such as crash boxes or bumpers. Mechanical mounting means, such as screws or rivets, as well as bonding are the preferred joining techniques. It is particularly preferred that no joints between rust-resistant steels and the conventional steels are established via welding.

According to the present invention, it is significantly important that steps b) and c) take place in sequence without a process step for applying an anti-corrosion coating being executed in between. This represents a substantial advantage of the present invention over the common method for constructing supporting frame structures, body-in-white structures, or the entire body-in-white construction.

The integral part of the color-providing surface coating of the exterior surface of the motor vehicle is preferably directly applied to the uncoated surfaces of rust-resistant steels, light metals, or plastics. This step may also be split up into partial steps which take place temporally separated by different manufacturing steps.

In a preferred embodiment of the present invention, at least part of the color-providing surface coatings are applied using the film technique. The color films, which may possibly also have special effects (effect film), are directly applied to the body components or the body-in-white in the desired vehicle color. The film technique may be combined with the painting technique, the flat body components in particular being coated using films, while the supporting structures are preferably painted.

In a preferred embodiment of the present invention, at least all flat body components and/or body panels of the body-in-white are covered with color films on the visible surfaces (as a rule the exterior) of the motor vehicle.

According to the present invention, the rust-resistant steels, used in the supporting frame structure, are selected from the low-carbon α steels, or the Ni-reduced and nitrogenized γ steels, or the virtually Ni-free α, γ duplex steels having a high Al content.

Only a single type of these steel grades is preferably used for the welded parts of the supporting frame structure, whereby only stainless/stainless weld seams are formed having a defined chemical and structural composition. Material incompatibilities at the welded joints are avoided and high corrosion resistance of the weld seams or weld spots is ensured in particular.

1. A motor vehicle comprising:
a stainless supporting frame structure formed of rust-resistant materials selected from the group consisting of rust-resistant steels, light metal alloys and plastics, and wherein the surface of the supporting frame structure is free of anti-corrosion coating and anti-corrosion painting.

2. The motor vehicle as recited in claim 1, further comprising a plurality of flat body components mounted on the stainless supporting frame structure so as to form a stainless body-in-white, wherein the flat body components are formed of rust-resistant materials selected from the group consisting of rust-resistant steels, light metal alloys and plastics, and wherein the surface of the body-in-white is free of anti-corrosion coating and anti-corrosion painting.

3. The motor vehicle as recited in claim 1, wherein the surface of the supporting frame structure is free from phosphatizing, chromatizing, and galvanizing.

4. The motor vehicle as recited in claim 1, wherein the supporting frame structure includes at least one of a light metal and a reinforced plastic.

5. The motor vehicle as recited in claim 1, wherein the reinforced plastic includes a fiber reinforced plastic.

6. The motor vehicle as recited in claim 1, wherein the rust-resistant steels include at least one of a low-carbon α steel, a Ni-reduced and nitrogenized γ steel, and a virtually Ni-free α, γ duplex steel having a high Al content.

7. The motor vehicle as recited in claim 6, wherein the α steel has one of the following compositions:
0.03% C; 17.5% to 18.5% Cr; 1% Si; 1% Mn; 0.1% to 0.6% Ti; the rest Fe and usual traces;
0.03% C; 10.5% to 12.5% Cr; 1% Si; 1% Mn; 0.1% to 0.6% Ti; the rest Fe and usual traces;
0.025% C; 17% to 20% Cr; 1% Si; 1.8% to 2.5% Mo; 1% Mn; <0.8% Ti; <0.03% N; the rest Fe and usual traces;
5% to 9% Al; 8% to 21% Cr; C <0.031%; the rest Fe and usual steel additives.

8. The motor vehicle as recited in claim 6, wherein the γ steel has one of the following compositions:
0.04% C; 0.05% N; 18% Cr; 8.3% Ni; the rest Fe and usual traces;
0.02% C; 0.04% N; 17.2% Cr; 10.2% Ni; 2.1% Mo; the rest Fe and usual traces;
0.1% C; 0.3% N; 17% to 19.5% Cr; 3.5% Ni; 1% Si; 6% to 9% Mn; the rest Fe and usual traces;
0.03% C; 0.15% to 0.3% N; 15% to 17% Cr; 1.5% to 3% Ni; 1% Si; 7% to 9% Mn; 1% Cu; the rest Fe and usual traces; and
0.1% to 0.2% N; 10% to 15% Cr; 8% to 15% Ni; the rest Fe and usual steel additives.

9. The motor vehicle as recited in claim 6, wherein the α, γ duplex steel has one of the following compositions:
0.1% C; 0.3% Si; 6.7% Mn; 18.9% Cr; 0.2% N; 1.5% Ni; the rest Fe and usual traces;
0.03% C; 0.22% N; 21.5% Cr; 1.5% Ni; 0.3% Mo; 5% Mn; the rest Fe and usual traces;
0.02% C; 5% Mn; 0.4% Si; 20% Cr; 1.6% Ni; 0.3% Cu; 0.13% N; the rest Fe and usual traces; and
0.3% to 0.8% C; 6% to 18% Al; 15%-25% Mn; the rest Fe and usual steel additives.

10. The motor vehicle as recited in claim 2, wherein the flat body components are disposed in at least one of a side section, a rear end section, and a front end section of a body of the vehicle.

11. The motor vehicle as recited in claim 10, wherein the flat body components include body panels.

12. The motor vehicle as recited in claim 2, wherein the predominant part of the flat body components include a color or effect film on an exterior surface of the vehicle.

13. The motor vehicle as recited in claim 1, wherein the predominant part of the supporting frame structure, visible from the outside, bears a color or effect film.

14. The motor vehicle as recited in claim 2, wherein a coloring of the body-in-white is effected exclusively using color films.

15. A method for manufacturing a motor vehicle having a corrosion-resistant body-in-white, the method comprising:
manufacturing a supporting frame structure by joining together rust-resistant steels; and
mounting a plurality of flat body components made of at least one of light metals, plastics, and rust-resistant steels, so as to form the body-in-white; and
directly applying a color-providing surface coating to an uncoated surface of the body-in-white.

16. The method as recited in claim 15, wherein the joining includes welding.

17. The method as recited in claim 15, wherein the flat body components include body panels.

18. The method as recited in claim 16, wherein only steels of identical grades are welded together in the body-in-white.

19. The method as recited in claim 15, further comprising mounting additional structure components made of at least one of light metals and plastics on the supporting frame structure.

20. The method as recited in claim 15, wherein the applying of the color-providing surface coating is performed using a color film.

21. The method as recited in claim 15, wherein the applying of the color-providing surface coating includes covering at least the flat body components panels disposed on the motor vehicle's exterior with a color film.

22. The method as recited in claim 15, wherein the rust-resistant steels are selected from the group consisting of low-carbon α steels, Ni-reduced and nitrogenized γ steels, and virtually Ni-free α, γ duplex steels having a high Al content.

23. The method as recited in claim 22, wherein the manufacturing of the supporting frame structure includes performing a shaping technique, the shaping technique including at least one of a deep drawing, a compression, a molding, a collar compression, a rolling, and a tapering of the rust-resistant steels.
